(19) United States
(12) Patent Application Publication
(10) Pub. No.: US 2014/0058855 A1
(43) Pub. Date: Feb. 27, 2014

(54) SYSTEM AND METHOD FOR MOBILE AND SOCIAL CUSTOMER RELATIONSHIP MANAGEMENT

(71) Applicant: Atif Hussein, Burlingame, CA (US)

(72) Inventors: Atif Hussein, Burlingame, CA (US); Joanna Livadas, Millbrae, CA (US); Premashish Deb, Fremont, CA (US)

(21) Appl. No.: 13/856,421

(22) Filed: Apr. 3, 2013

Related U.S. Application Data
(60) Provisional application No. 61/619,832, filed on Apr. 3, 2012.

(51) Int. Cl. G06Q 20/40; G06Q 20/20

(52) U.S. Cl. CPC G06Q 20/405; G06Q 20/20
USPC 705/16

(57) ABSTRACT

Methods and systems for facilitating electronic transactions using one or more computer based devices and remote requests and authorizations for funding proposed transactions for products or services.

### RELATED APPLICATION

This application claims priority to U.S. Provisional Application No. 61/619,832 filed Apr. 3, 2012, hereby incorporated by reference.

### FIELD OF THE INVENTION

The present disclosure relates generally to computer-based methods and systems and, more particularly, to a system and method for mobile social commerce and electronic transactions.

### BACKGROUND OF THE INVENTION

A voucher is a bond which is worth a certain monetary value and which may be spent only for specific reasons or on specific goods. Examples include (but are not limited to) housing, travel, and food vouchers. The term voucher is also a synonym for receipt and is often used to refer to receipts used as evidence of, for example, the declaration that a service has been performed or that an expenditure has been made.

In marketing, a coupon is a ticket or document that can be exchanged for a financial discount or rebate when purchasing a product.

Customarily, coupons are issued by manufacturers of consumer packaged goods or by retailers, to be used in retail stores as a part of sales promotions. They are often widely distributed through mail, coupon envelopes, magazines, newspapers, the Internet, directly from the retailer, and mobile devices such as cell phones. Since only price conscious consumers are likely to spend the time to claim the savings, coupons function as a form of price discrimination, enabling retailers to offer a lower price only to those consumers who would otherwise go elsewhere. In addition, coupons can also be targeted selectively to regional markets in which price competition is great.

The term virtual gift may refer to a gift consisting of a picture of an item, instead of the item itself, usually through the interne. It can also refer to a gift consisting of an item in a virtual world. The item may have a digital social capital value, esthetic or functional value. The item may or may not be paired with an offline equivalent. A virtual gift can also be an alternative gift, a form of gift giving in which the giver makes a donation to a charitable organization in the recipient's name, rather than giving an item.

Virtual goods are non-physical objects that are purchased for use in online communities or online games.

### SUMMARY OF THE INVENTION

The invention relates to computed-implemented or computer-based methods and systems for mobile social commerce or mobile electronic transactions.

One aspect of the invention relates to systems and method for implementing, conducting or performing electronic transactions utilizing digital photos from the point of sale to obtain authorization from remote party to fund and/or authorize the purchase.

Another aspect of the invention relates to methods and systems for facilitating remote transactions using computerized devices without being present at the location. In the past, individuals can send their physical credit card to the merchant location with a person (e.g., an employee) or provide the credit card information over the phone to make a remote purchase.

Another aspect of the invention relates to improve electronic transactions using mobile computerized devices at remote locations.

Another aspect of the invention, the funding of a requested transaction by one or multiple approvers.

Another aspect of the invention relates to methods and systems allowing the individual(s) required to approve a particular transaction to be dynamically selected based on the transaction parameters such as item(s) being purchased, day of week (weekday or weekend), date, time of day, location, funding amounts requested and other parameters.

Another aspect of the invention relates to electronic transactions incorporating geolocation parameters.

Another aspect of the invention relates on-demand or dynamic approvals of payments or funds based on transaction parameters. For example, the on-demand generation of a virtual payment card based on approver set parameters.

Another aspect of the invention relates to methods of facilitating providing one or more gifts to an individual based on the individual's location determined by the individual's smartphone or other mobile device.

The systems, methods, features and advantages of the invention will be or will become apparent to one with skill in the art upon examination of the following figures and detailed description. It is intended that all such additional methods, features and advantages be included within this description, be within the scope of the invention, and be protected by the accompanying claims. It is also intended that the invention is not limited to require the details of the example embodiments.

### BRIEF DESCRIPTION

The accompanying drawings, which are included as part of the present specification, illustrate the presently preferred embodiment and, together with the general description given above and the detailed description of the preferred embodiment given below, serve to explain and teach the principles of the present invention.

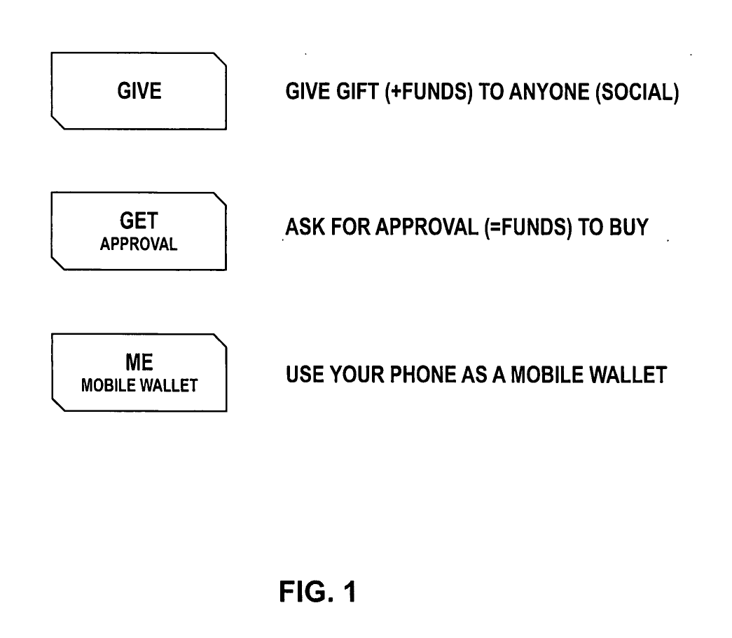

FIG. 1 is a graphical representation of exemplary available user actions for use with the methods and systems according to one embodiment.

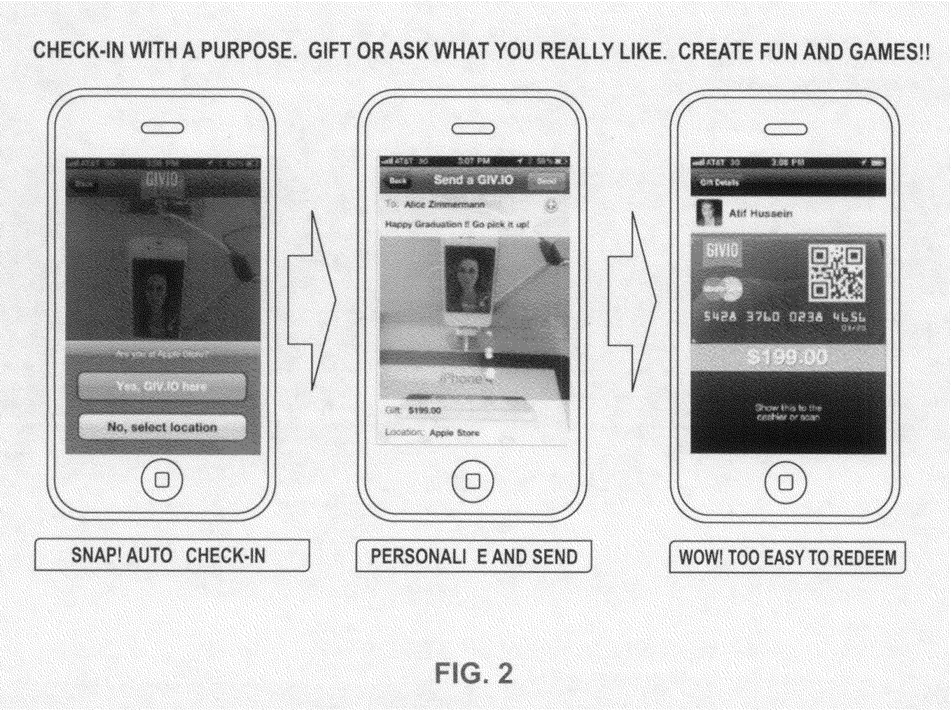

FIG. 2 illustrates further exemplary available user actions and interfaces on a smartphone for use with the methods and systems according to another embodiment.

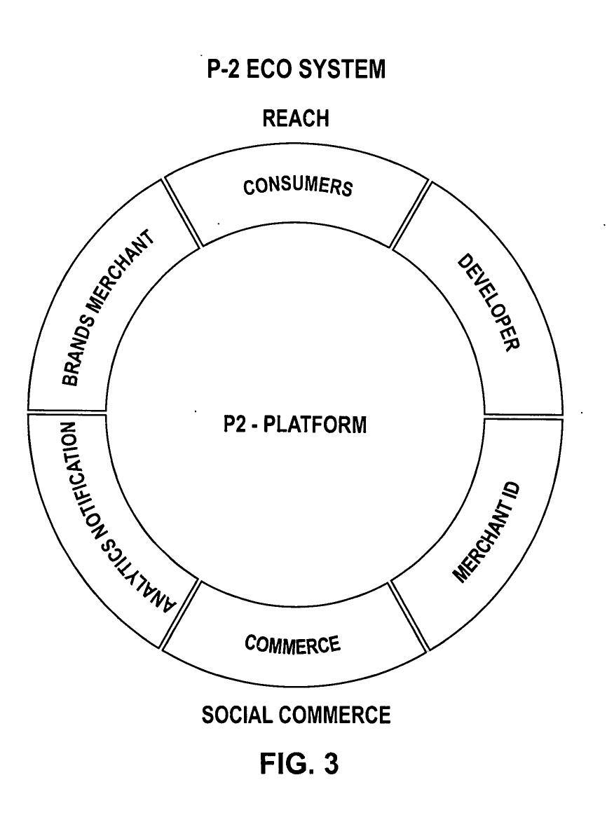

FIG. 3 is a graphical representation of an exemplary transaction/commerce eco-system for use with the methods and systems according to another embodiment.

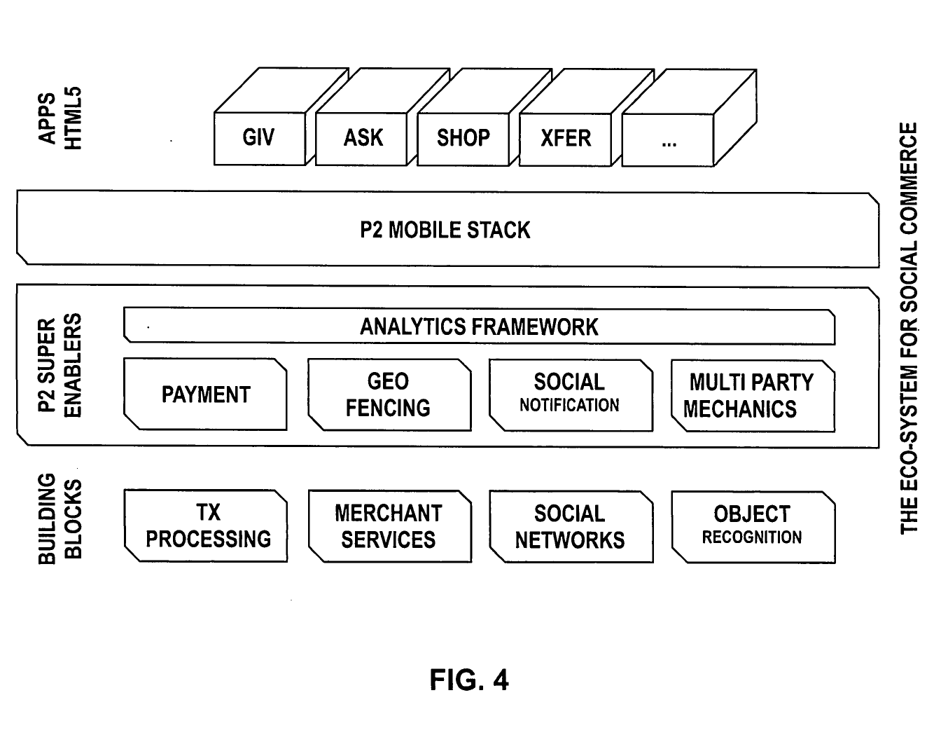

FIG. 4 is a graphical representation of an exemplary computer based system for use with the methods and systems according to another embodiment.

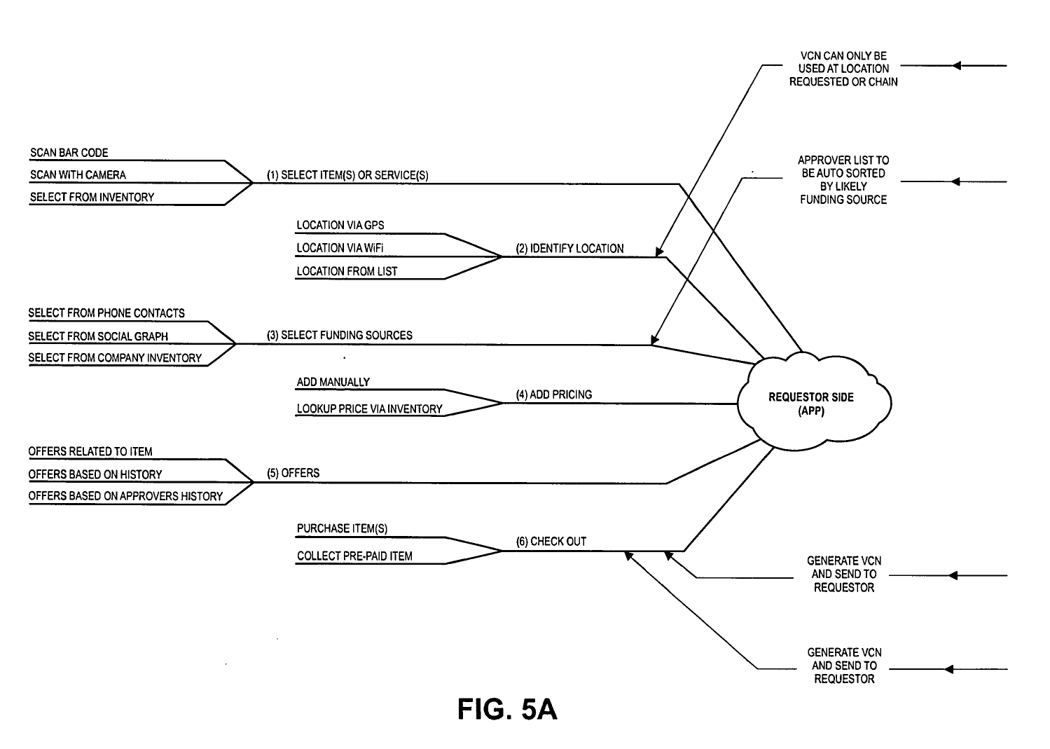

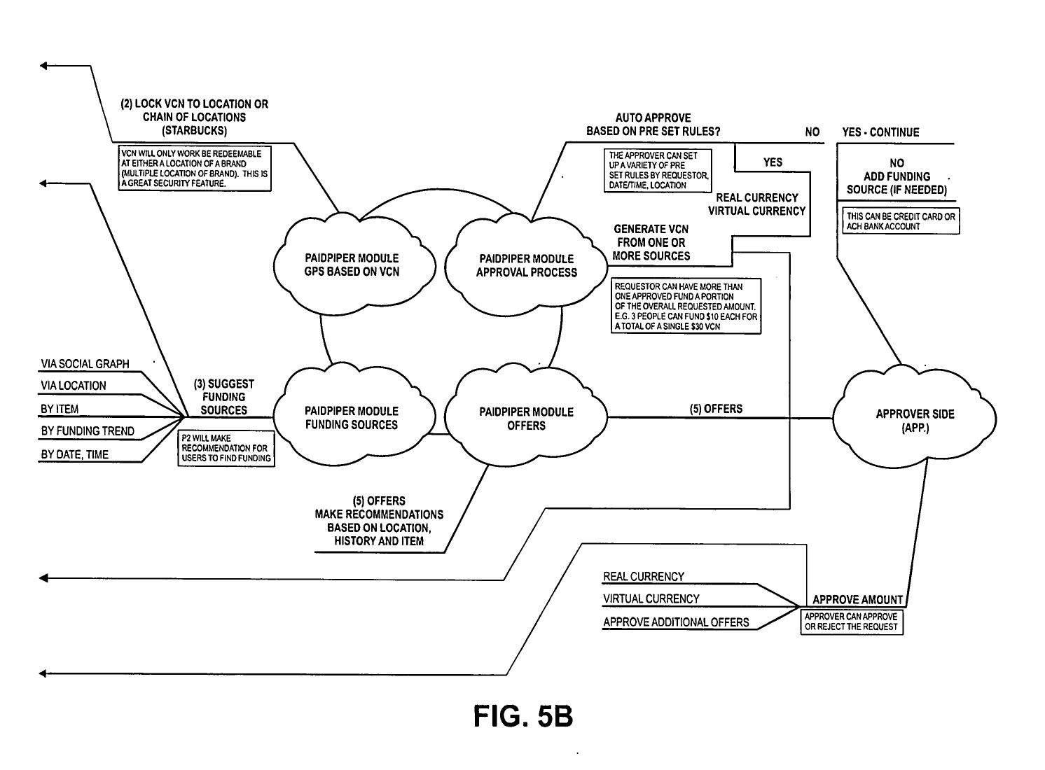

FIGS. 5A and 5B are graphical representations of an exemplary flow chart of methods and systems according to another embodiment.

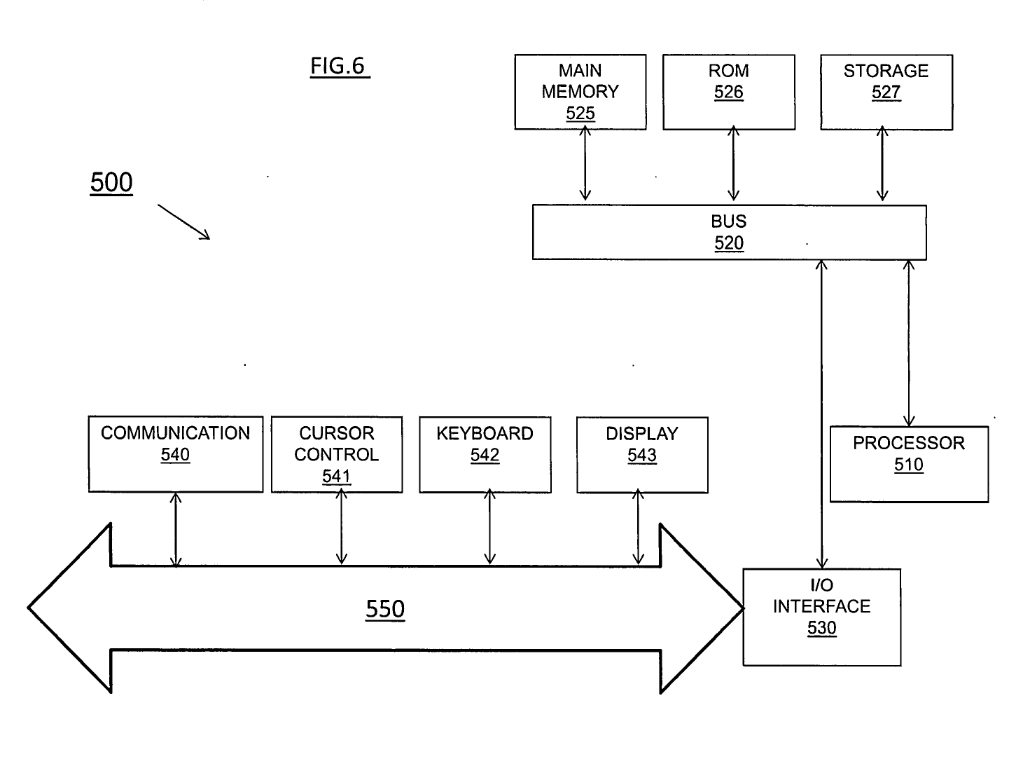

FIG. 6 illustrates an exemplary computer architecture for use with the methods and systems according to another embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not necessarily describe every aspect of the teachings disclosed herein and do not limit the scope of the claims.

### DETAILED DESCRIPTION

The present disclosure includes a computer-based or computer implemented platform for personalized mobile payments. The present system streamlines the overly complex space of instant coupons and electronic payments to allow individuals, companies, firms, enterprises and services to leverage mobile technologies and/or add a simple payments layer or process to their offerings.

FIG. 1 illustrates exemplary available user actions for use with the present system, according to one embodiment. A user of the present system can give a gift (in the form of currency) to anyone. The user may also request approval and receive currency for a targeted purchase. The user may further use a mobile device as a wallet. The user may further use the system as a primary method of paying for good and services be linking it to their credit card, bank account, or other means of funding source.

The invention relates to methods and systems for facilitating electronic transactions, preferably relating to the purchase of services or products.

According to one embodiment, the present system enables a user to request approval and funding for a specific transaction. As an example, the user may take a picture (using a mobile device) of a desired item for purchase, have it pre-funded by another individual, and then pay for it at a point of sale (POS) without needing cash, credit card or checkbook or needing an existing banking relationship.

Another embodiment of the invention relates to systems and method for implementing, conducting or performing electronic transactions utilizing digital photos from the point of sale by a purchasing user to obtain authorization from remote party to fund and/or authorize the purchase.

Preferably, the methods and systems transmits the transaction request to an approving user who authorizes the request based on one or more digital photos of the item(s) to be purchased and, preferably also the amount of funds needed for the transaction and the location of the transaction and the identity of the purchasing user.

According to preferred embodiments, a purchasing individual with a smartphone (or other mobile computer device) takes one or more pictures of the item(s) to be purchased at the retail location and the images are electronically transmitted to remote individual(s) (e.g., approving user) who are authorized or able to fund the purchase of the item with funds, credit or other means. The remote approving individual can review the images along with other transaction information (e.g., price, discounts, number of items, warranty offered, retail location, expiration date(s), etc.), preferably on the approving individual's computerized device. If the proposed purchase transaction is acceptable, the remote approving party can authorize the use of the approving party's credit or funds for the transaction. Preferably, the authorization is displayed on the purchasing individual's smartphone (or other device) and can then be shown to the retail employee to complete the purchase transaction.

Preferably, the redeeming the funds at a point of sale for the purchase is performed by a purchasing user using a computer device such as a smartphone or other mobile device. Preferably, the computer device is selected from the group consisting of smartphone, tablet, laptop, computerized watch, or computerized eyewear. According to preferred embodiments, the approving user and purchasing user are using and/or communicating via mobile devices allowing for real-time authorizations of purchases.

One embodiment of the invention relates to a method of performing an electronic transaction comprising:

(a) receiving a request, using one or more computer devices, from a purchasing user to approve and fund a transaction to purchase a product, wherein the request includes at least one digital photo of the product;

(b) transmitting the request including the photo to an approving user;

(c) accepting pre-funding for the transaction from the approving user; and

(d) redeeming the funds at a point of sale.

Preferably, the approving user owns or controls the funds or credit used in the transaction. Preferable, the approving user is effectively making the purchase via the purchasing user. That is, the purchasing user does not need to offer credit or funds and also does not obtain direct access to the credit or funds of the approving user or the data describing the credit or funds since the credit or funds are used directly for making the purchase set forth in the transaction request. Preferably, the funds are generated from a credit line belonging to the approving user. Preferably, the fund source or descriptions are never revealed to the requesting user at the point of sale merchant.

According to preferred embodiments, the redeeming of the funds comprises displaying credit card or credit line or other funding information on a mobile computer device carried by the purchasing user generated by the method.

According to preferred embodiments, the purchasing user's mobile computer device also displays the purchasing user's identification, profile or other authorization information. According to other preferred embodiments, the purchasing user's mobile computer device also displays the funding or approving user's identification, profile or other authorization information.

According to preferred embodiments the approving user is a parent, grandparent, spouse or guardian of the purchasing user. According to other preferred embodiments, the approving user is a manager or owner of a company and the purchasing user is an employee or agent of the company. According to other preferred embodiments, a deal or coupon (e.g., $10 off) from a brand or merchant is displayed on the purchasing user's smartphone or computer device and the purchasing user is an individual shopping at the brand or merchant location.

Preferably, the authorization for the funds for the transaction is received from the approving user in an authorization message from the approving user's computer device, preferably mobile computer-based device.

According to another embodiment, the method further comprises, after receiving acceptance of the request:

(i) determining whether one or more redemption rules associated with electronic transactions apply to the redemption of funds at the point of sale;

(ii) processing the redemption if all redemption rules determined to be applicable are satisfied; and

(iii) denying the redemption if one or more redemption rules determined to be applicable are not satisfied;

wherein the processing includes the redeeming of the funds at the point of sale for the purchase.

Preferably the one or more redemption rules include validating the funds and one or more transaction parameters. Preferably, the one or more transaction parameters relate to the product or service, point of sale location, date and/or time.

Preferably, the step of requesting approval comprises taking a picture of a desired item for purchase or the desired item's barcode or other identifying image.

Preferably, the step of requesting approval comprises recording a location associated with a retail location or brand and/or the desired item's price.

Preferably, the step of redeeming the funds at a point of sale comprises presenting a virtual card to a merchant or retail employee at the point of sale.

Another embodiment of the invention relates to a method of performing an electronic transaction comprising:

(a) receiving a request over a network from a purchasing user to approve and fund a transaction to purchase a product and at least one digital photo of an item to be purchased;
(b) determining whether one or more rules associated with electronic transactions apply to the request from the purchasing user;
(c) processing the request if all rules determined to be applicable are satisfied; and
(d) denying the request if one or more rules determined to be applicable are not satisfied; wherein the processing includes:
(i) transmitting the request including the one or more digital photos to an approving user;
(ii) receiving acceptance of the request for the transaction from the approving user; and
(iii) redeeming the funds at a point of sale for the purchase.

According to preferred embodiments, the method further comprises applying one or more redemption rules at point of sale before redemption can be completed (location, expiry date or date/time range). Preferably, the applying of one or more redemption rules at point of sale includes rules relating to location, expiry date, date, and/or time.

Another aspect of the invention relates to methods and systems for facilitating remote transactions using computerized devices without being present at the location. In the past, individuals could send their physical credit card to the merchant location with a person (e.g., an employee) or provide the credit card information over the phone to make a remote purchase.

According to the invention, using mobile computer-based technology, individuals can “send the money” via another individual's mobile computer-based device (e.g., smartphone or the like) at the merchant location without sending their personal credit card data to the merchant or the smartphone owner. For example, a parent can approve a purchase transaction requested by a son via the son's smartphone allowing to son to merely show the smartphone display with the approved credit card or funding authorization to merchant or employee of the retail location to complete the transaction.

According to the invention, individuals with credit or funds can better control their money and make the credit and funds more readily available in a controlled manner to family, employees and others. The money used in a transaction according to the invention is theirs and is to be used for the sole purpose to buy the identified items or services at that specific merchant location, preferably regardless of whether who the on site purchaser is so long as the purchaser is approved or authorized by the funding user. Additionally if the transaction is not completed or is partially completed either all or the remaining monies are returned to the funding individual and are not retained by the purchasing individual or merchant.

One embodiment relates to a “piggy-back” method of allowing a funding party to use a 3rd user computer terminal to make an electronic transaction at a geo-location other than that of funding party's location. The invention is referred to as a “piggy-back” method since a funding party or authorizing user is using another individual's smartphone (or other computer device) at a remote location to purchase a product or service at the remote location.

For example, User A is carrying a smartphone equipped with the application or software for implementing the invention. User A enters a store and notices a product her friend User B has been searching for. User A preferably snaps a photo of the item sends a request to fund with a note about the price and related information. User B is notified on her smartphone, views the item and product information and approves the purchase with her credit card or funds. User A then receives the authorization on her smartphone to make the purchase with User B's credit or funds funds by showing the authorization to the retail employee. Preferably, the authorization displayed on User A's smartphone includes a uniquely generated credit card limited in value to the amount approved by User B, a description of the item being purchased and, preferably, an indication the funds or credit are providedfor the sole purpose of the purchase for User B. Preferably, the authorization includes a code or similar verification methodology generated by the method or system which provides confirmation and verification to the retail employee that the authorization is approved by the source of the funds or credit.

Preferred embodiments relate to methods comprising:
(a) receiving a request for purchase over a network for a good or services;
(b) funding the transaction using one or more rules (preferably the rules predetermined or based on real-time user input based on conditions which 3rd user computer terminal is initiating the request); and
(c) allowing a third party user computer terminal to complete the transaction on the funding party's behalf at desired point of sale location.

Preferably, the resulting transaction actions can be one of the following:
(i) transaction complete and all received funds used;
(ii) transaction complete with partial funds remaining being returned to funding source;
(iii) transaction cancelled/uncompleted returning all funds to funding source.

Preferably, the funds or credit are always the property of the source of the funds or credit (e.g., funding party or approving party). The third party user computer device acts as a “piggy-back” delivery mechanism to complete transaction over the network at a location remote from the user of the funds or credit.

Another embodiment of the invention relates to a method of performing an electronic transaction comprising:
(a) receiving a request over a network from a remote funding user to fund a transaction to purchase a product or service at a location using a third user purchaser computer device at the location;
(b) determining whether one or more rules associated with electronic transactions apply to the request from the funding user;
(c) processing the request if all rules determined to be applicable are satisfied; and
(d) denying the request if one or more rules determined to be applicable are not satisfied;
   wherein the processing includes:
   (i) transmitting confirmation of funds from the remote funding user for the transaction to the third user purchaser computer device; and
   (ii) redeeming the funds at a point of sale for the purchase of the products or services.

According to preferred embodiments, the method further comprises receiving a funding request over a network from the third user purchaser computer device to approve and fund the transaction to purchase the product or service prior to the request.

Preferably, the method further comprises:
(i) determining whether one or more rules associated with electronic transactions apply to the funding request;
(ii) processing the funding request if all rules determined to be applicable are satisfied; and
(iii) denying the funding request if one or more rules determined to be applicable are not satisfied;

wherein the processing includes transmitting the funding request over the network to the funding user.

According to other preferred embodiments, the one or more rules include predetermine purchase parameters. Preferably, purchase parameters include item type, merchant, retail location, price, discount, warranty, purchasing party affiliation to funding source, day, time, location and other factors.

According to preferred embodiments, the funds are returned to the funding user if the transaction is cancelled.

According to preferred embodiments, a portion of the funds is returned to the funding user if the transaction is partially filled.

Another aspect of the invention relates to improved electronic transactions.

One embodiment of the invention relates to a method of performing an electronic transaction comprising:
(a) receiving a request over a network from a purchasing user to approve and fund a transaction to purchase a product or service;
(b) determining whether one or more rules associated with electronic transactions apply to the request from the purchasing user;
(c) processing the request if all rules determined to be applicable are satisfied; and
(d) denying the request if one or more rules determined to be applicable are not satisfied;
   wherein the processing includes:
   (i) transmitting the request to an approving user;
   (ii) receiving acceptance of the request for the transaction from the approving user; and
   (iii) redeeming the funds at a point of sale for the purchase.

Preferably one or more rules are associated and applied with redeeming the funds. For example, when a purchasing user redeems the funds at point of sale or retail location, the fund or credit authorization (e.g. virtual credit cards) will then be checked for validity over a network or in the cloud (e.g., the purchase amount, credit card expiration, merchant ID if present, valid date or time parameters (e.g., can only be used between 9 am and 5 pm) etc.).

Preferably, the method or system generates the pre-paid virtual credit card “on the fly” or in real-time at the retail location (e.g., via a smartphone display). Preferably, the picture of the item being funded is preferably displayed as the background image of the virtual card for additional security.

Another embodiment of the invention relates to a method comprising: (i) requesting approval and funding for a transaction; (ii) accepting pre-funding for the transaction; and (iii) redeeming the funds at a point of sale.

Preferably, the step of requesting approval comprises taking a digital photo of a desired item for purchase and electronically transmitting the digital photo to a party providing the approval and funding.

Preferably, the step of requesting approval comprises recording a location associated with a merchant, retail location, chain or brand.

Preferably, the step of redeeming the funds at a point of sale comprises presenting a virtual card to a merchant at the point of sale, preferably using a mobile computerized device such as a smartphone.

FIG. 2 illustrates further exemplary available user actions and interfaces for use with the present system, according to one embodiment where a remote user (Atif) sends a user at a retail location (Alice at an Apple Store) a gift, namely authorization for Alice to purchase an iphone with Atif's credit or funds. As scene on the first smartphone display (on left), geolocation technology is utilized to pinpoint Alice's location at an Apple Store. Preferably, other contacts (including Atif) are notified when Alice enters the store. Either the system or a contact (e.g., Atif) requests Alice to confirm her location. After confirmation of location, Alice receives a message from a contact (Atif) regarding the gift. The last screen shows the virtual credit card display on Alice's smartphone to show the merchant to purchase the product. Preferably, the authorization information includes the amount authorized (e.g., $199), credit card information or image (e.g., Mastercard, Visa or similar) and the purchaser's identify or image for additional security on the virtual card itself. Preferably, the authorization information includes or also includes the approving users information, name, picture and any conversational text for supporting and informational purposes.

FIG. 3 is an exemplary eco-system for use with the present system according to one embodiment illustrating a wide variety of transactions possible using the invention. Electronic platforms according to the present system reaches consumers, developers, and brand merchants. The platform also enables social customer relationship management (CRM) through analytics, merchant information, and commerce transactions.

FIG. 4 further illustrates an exemplary eco-system for use with the present system according to another embodiment. The eco-system of the preferred embodiment includes application support, enablers, and building blocks. Application support can be for currency giving/transferring, requesting (asking), and redemption (shopping), according to one embodiment. Enablers include analytics support, payment support, geo-fencing, social notifications, social CRM analytics, and multi party mechanisms. The building blocks include transaction processing, merchant services, social networks, and object recognition.

FIGS. 5A and 5B illustrate an exemplary flow charts showing processes according to another embodiment. An item or service is selected (at a requester side) for purchase. A location is identified as being associated with the item or service. Such location can be physical or it can be associated with a chain or brand. A funding source is recommended and/or selected to fund the purchase of the item or service. Such funding source could be a manager at work or friends and family via a social network. In the case that the Physical or Virtual Card was given to the user as a business card or such, the Promoter could be the funding source in exchange for further actions by the Customer. Pricing is determined, and offers are optionally generated and/or reviewed (related to the item or service). A virtual credit card number (VCN—Virtual Card Number) is generated for the item or service (at an approver side), and the item or service is purchased (or collected as a pre-paid item). This shows the “real-time” nature of “ask & approve” cycle using mobile phone and mobile networks to route information and to complete transactions.

According to another embodiment, the present system securely validates the identity and influence of customers for promoters. As an example, the present system can perform a N-way match using the customer's entered phone number, Facebook profile, LinkedIn profile, email address, and/or secure ID capability on mobile devices. Not only does the matching enable validating the identity of the customer, it also enables the calculation of an influence score for the customer. Promoters, for example, may use the influence score to determine an amount of currency to provide to the customer. These validation or influence scoring methods can be incorporated in the transaction methods described herein to improve the electronic transactions.

Another aspect of the invention relates to methods and systems for funding requested transactions with one, two or multiple approvers. Preferably, different types of transactions can have different chains of approval depending on the transaction parameters, purchasing user and other factors.

One embodiment of the invention relates to a method of performing an electronic transaction comprising:
(a) receiving a request over a network from a purchasing user to approve and fund a transaction to purchase a product or service;
(b) determining whether one or more rules associated with electronic transactions apply to the request from the purchasing user;
(c) processing the request if all rules determined to be applicable are satisfied;
(d) denying the request if one or more rules determined to be applicable are not satisfied;
(e) transmitting the request to a first approving user selected from two or more approving parties;
(f) receiving acceptance of the request for the transaction from the first approving user;
(g) transmitting the request to a second approving user selected from two or more approving parties;
(h) receiving acceptance of the request for the transaction from the second approving user; and
(d) redeeming the funds at a point of sale for the purchase of the product or service.

According to one preferred embodiment, the first approving user and the second approving user are each parents or guardians of the purchasing user.

According to one preferred embodiment, the first approving user and the second approving user are employees of the same company.

According to one preferred embodiment, the first approving user and the second approving user each review the request and transmit their approval via mobile computer-based devices.

Preferably, if the second approving user declines the request, the first approving user is notified electronically.

Preferably, if the second approving user declines the request, the first approving user is notified electronically and can re-route the request to another approving user.

Preferably, if the second approving user fails to respond to the request within a specified period of time, the first approving user is notified electronically and can re-route the request to another approving user.

Preferably, the second approving user and the first approving user each receive notifications after the transaction is completed.

Another aspect of the invention relates to methods and systems allowing the individual(s) required to approve a particular transaction to be dynamically selected based on the transaction parameters such as item(s) being purchased, day of week (weekday or weekend), date, time of day, location, funding amounts requested and other transaction parameters. For example, a purchasing user may be an employee, but also a minor. If it's the weekend, the funding request may be sent to the individual's parent for approval and funding, while during the week the request may be sent to the employer or manager.

Preferably, two or more parameters are used to select the approving user. For example, day of week/product type or retail location/time of day.

According to preferred methods and systems, the purchasing user can select the transaction parameters associated with each approving user. For example, a purchasing user may wish to dynamically select whether a funding request should be sent to his or her employer (e.g., during a weekday afternoon) or simply be charged to a personal account (preferably requiring no further approvals). Thus, preferred embodiments of the invention allow for the dynamic routing of payment authorizations based on transaction parameters.

As another example, a purchasing user may select proposed purchases from certain retail locations (e.g., office supplies) to be sent to a company, manager or business account, while purchases at a supermarket be sent to a spouse for approval or to a personal credit card or funding account.

According to other preferred methods and systems, the approving user selects the transaction parameters associated with the approving user funding authorizations. For example, a parent may select the types of transaction requests the parent wishes to receive from their children. That is, allow funding requests from children based on transaction parameters such as product type, retail location, amount of funds requested, time of day, etc.

Preferably, the selection of the approver is dynamically based on transaction parameters (including but not limited to item(s) price, merchant location, category of item(s), time of day, etc.).

Another embodiment relates to a method of performing an electronic transaction comprising:
(a) receiving a request over a network from a purchasing user to approve and fund a transaction to purchase a product or service, wherein the request includes one or more transaction parameters;
(b) determining whether one or more rules associated with electronic transactions apply to the request from the purchasing user;
(c) processing the request if all rules determined to be applicable are satisfied;
(d) denying the request if one or more rules determined to be applicable are not satisfied;
(e) transmitting the request to a first approving user selected from two or more approving users, the selection based on the transaction parameters;
(f) receiving acceptance of the request for the transaction from the first approving user; and
(d) redeeming the funds at a point of sale for the purchase of the product or service.

Preferably, the transaction parameters are one or more parameters selected from: (i) location, (ii) product type, (iii) price, (iv) day of week, and (v) time of day.

Preferably, the first approving user is selected automatically based on the transaction parameters.

Preferably, the two or more approving users are automatically provided for selection based on the transaction parameters and the purchasing user selects the first approving user from said two or more approving users.

Preferably, the first approving user is selected automatically based on the transaction being work-related.

Preferably, the first approving user is selected automatically based on the transaction being personal use-related.

Preferably, the first approving user is selected automatically based on the transaction being education-related.

Preferably, the first approving user is selected automatically based on the transaction being related to a specific account.

Another aspect of the invention relates to electronic transactions incorporating geolocation parameters. Preferably, restricting the display and/or use of a payment card or funds to a geographical region using a mobile device geolocation information. For example. displaying the credit card “on location” via a smartphone or other computer device (e.g., tablet, computerized watch, computerized eyewear, etc.) Using geolocation information from a computerized device, electronic transactions can incorporate location-based information such as the specific retail location or enterprise or neighborhood.

One embodiment relates to a method of performing an electronic transaction comprising:
(a) receiving a request over a network from a purchasing user to approve and fund a transaction to purchase a product or service at a location;
(b) determining the location using one or more computers;
(c) determining whether one or more rules associated with electronic transactions apply to the request from the purchasing user and the determined location;
(d) processing the request if all rules determined to be applicable are satisfied;
(d) denying the request if one or more rules determined to be applicable are not satisfied;
(e) transmitting the request to an approving user;

(f) receiving acceptance of the request for the transaction from the approving user; and
(g) redeeming the funds at a point of sale for the purchase.

Preferably, the request is transmitted to the approving user based on the determined location.

Another aspect of the invention relates on-demand or dynamic approvals of payments or funds based on transaction parameters. For example, the on-demand generation of a virtual payment card based on approver set parameters. The methods and systems can use conventional technologies such as those described in U.S. Pat. No. 8,296,228 to Kloor and U.S. Pat. No. 8,285,648 to Goodin, hereby incorporated by references, particularly the point of sale methods and systems described therein.

The present system enables a mobile wallet. A mobile device can issue a safe and secure payment on the fly at remote locations.

One embodiment of the invention relates to a method of performing an electronic transaction comprising:
(a) receiving a request over a network from a purchasing user to approve and fund a transaction to purchase a product or service;
(b) determining whether one or more rules associated with electronic transactions apply to the request from the purchasing user;
(c) processing the request if all rules determined to be applicable are satisfied;
(d) denying the request if one or more rules determined to be applicable are not satisfied; and
(e) redeeming the funds at a point of sale for the purchase,

wherein the one or more rules include purchase parameters for the purchasing user, the purchase and/or the transaction.

Another aspect of the invention relates to methods of facilitating providing one or more gifts to an individual based on the individual's location determined by the individual's smartphone or other mobile device. The present system leverages social gifting and/or social commerce. According to one embodiment, an example of a social gift includes a user gifting an actual cupcake from a favorite local store to a friend for their birthday (e.g. via Facebook), rather than a virtual gift. The social gift is specifically redeemable for the cupcake and is tied to the receiver.

For example, Jane is carrying a smartphone and walks into a retail location. Jane's friend, Mike, receives a message that Jane entered the store. Since Mike forgot Jane's birthday, again, he decides to make it up by sending her a gift message via her smartphone, preferably including a gift item located at the retail outlet, and the message allows Jane to redeem the electronic gift at the retail outlet. Preferably, the message includes Mike's credit card or other funding information authorization the merchant to provide Jane with the gift in “real-time” providing a nice surprise for Jane and getting Mike off the hook.

One embodiment of the invention relates to a method comprising:
identifying a user's location using a computer device carried by the user;
generating a message with a gift associated with the location;
transmitting the message with the gift to the user's location,

wherein the method is performed using one or more computer-based devices.

Preferably, the step of creating a message with a gift comprises: validating a sender's identity using more than one of the sender's phone number, social networking profiles, email address, and/or secure ID on a mobile device.

Preferably, the step of creating a message with a gift comprises: sending payment for the virtual gift using a linked credit card or bank account.

Preferably, the transmitted message includes a voucher for redemption at the user's location.

Another embodiment of the invention relates to a method comprising:
identifying a user's location using geolocation provided by a computer device;
creating a message with a gift associated with the location; and
transmitting the message with the gift to the user's location.

Preferably, the step of creating a message with a gift comprises validating a sender's identity using more than one of the sender's phone number, social networking profiles, email address, and/or secure ID on a mobile device.

Preferably, the step of creating a message with a gift comprises sending payment for the virtual gift using a linked credit card or bank account (e.g., an account previously authenticated).

Preferably, the transmitted message includes a voucher for redemption at the user's location.

Another aspect of the invention relates to systems and computer-based devices adapted or configured to perform the above-described methods of the invention.

One embodiment of the invention relates to a computer based system capable of performing any of the methods described-above comprising at least one computer device comprising a processor coupled to a memory, the memory having computer readable code, which when executed by the processor causes the computer based system to perform the method.

Another embodiment of the invention relates to a computer based electronic payment system capable of performing any of the methods described herein comprising at least one computer device comprising a processor coupled to a memory, the memory having computer readable code, which when executed by the processor causes the electronic payment system to perform the method.

Preferably, the method is distributed over a network of computer devices. For example, multiple mobile computed-based devices and other computers.

Preferably, the method further comprises transmitting messages between the purchasing user and the approving user.

According to preferred embodiments, adoption by merchants for the present system does not require new POS's or a change in process. For consumers, the present system runs on all types of mobile devices including feature phones.

According to one embodiment, mobile payments of the present system come in various forms, examples of which include vouchers, paper business cards, plastic business cards, hospitality cards (hotel or cruise room keys), conference badges, retail brand cards, identification cards, drivers licenses, virtual cards (displayed on a mobile device), live electronic cards (wifi enabled), and any card having a magnetic strip, micro processor or wireless transmitting capability (Near Field Communications chip, WiFi or RF).

According to another embodiment, a live electronic card includes a live indicator of the card balance, preferably on the funding user's or purchasing user's smartphone or other computer device. For example, an LED may indicate with a first color that the card balance is above a particular threshold, while indicating with a second color that the card balance is below a particular threshold. As another example, the card may display various graphics representing card balance.

According to another embodiment, currency associated with mobile payments of the present system include cash, minutes, points, badges, stamps, and any appropriate credit mechanism.

According to another embodiment, the present methods and systems provide for a promoter interface and a consumer/customer interface (interfaces also referred to herein as dashboards). A promoter dashboard provides a centralized interface including information related to customer data/identity, tracking of funds, advertisements to customers, sending polls/offers/questions to customers, and refilling (re-charging or topping up) cards/payments. A consumer interface includes information related to balances, transaction amounts, restrictions, offers, and the promoter or brand.

FIG. 6 illustrates an exemplary computer architecture for use with the present system, according to one embodiment. One embodiment of architecture 500 comprises a system bus 520 for communicating information, and a processor 510 coupled to bus 520 for processing information. Architecture 500 further comprises a random access memory (RAM) or other dynamic storage device 525 (referred to herein as main memory), coupled to bus 520 for storing information and instructions to be executed by processor 510. Main memory 525 also may be used for storing temporary variables or other intermediate information during execution of instructions by processor 510. Architecture 500 also may include a read only memory (ROM) and/or other static storage device 526 coupled to bus 520 for storing static information and instructions used by processor 510.

A data storage device 527 such as a magnetic disk or optical disc and its corresponding drive may also be coupled to computer system 500 for storing information and instructions. Architecture 500 can also be coupled to a second I/O bus 550 via an I/O interface 530. A plurality of I/O devices may be coupled to I/O bus 550, including a display device 543, an input device (e.g., an alphanumeric input device 542 and/or a cursor control device 541).

The communication device 540 allows for access to other computers (servers or clients) via a network. The communication device 540 may comprise one or more modems, network interface cards, wireless network interfaces or other well known interface devices, such as those used for coupling to Ethernet, token ring, or other types of networks.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples. A system and method for mobile social commerce have been disclosed. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

1. A method of performing an electronic transaction comprising:
(a) receiving a request over a network from a purchasing user to approve and fund a transaction to purchase a product and at least one digital photo of an item to be purchased;
(b) determining whether one or more rules associated with electronic transactions apply to the request from the purchasing user;
(c) processing the request if all rules determined to be applicable are satisfied; and
(d) denying the request if one or more rules determined to be applicable are not satisfied;
wherein said processing includes:
(i) transmitting said request including said one or more digital photos to an approving user;
(ii) receiving acceptance of said request for said transaction from said approving user; and
(iii) redeeming the funds at a point of sale for said purchase.

2. The method of claim 1, wherein said approving user owns or controls the funds used in said transaction or the funds are generated from a credit line belonging to said approving user.

3. The method of claim 1, wherein said redeeming of funds comprises displaying credit card or credit information on a mobile computer device carried by said purchasing user.

4. The method of claim 3, wherein said mobile computer device also displays the approving user's identification, profile or other verifying or authorizing information.

5. The method of claim 1, wherein authorization for said funds for said transaction is received from said approving user in an authorization message from said approving user's computer device.

6. The method of claim 1, further comprising, after receiving acceptance of said request:
(i) determining whether one or more redemption rules associated with electronic transactions apply to the redemption of funds at said point of sale;
(ii) processing the redemption if all redemption rules determined to be applicable are satisfied; and
(iii) denying the redemption if one or more redemption rules determined to be applicable are not satisfied;
wherein said processing includes said redeeming of said funds at said point of sale for said purchase.

7. The method of claim 6, wherein said one or more redemption rules include validating the funds and one or more transaction parameters.

8. The method of claim 7, wherein said one or more transaction parameters relate to the product or service, point of sale location, date and/or time.

9. The method of claim 1, wherein said redeeming the funds at a point of sale for said purchase is performed by a purchasing user using a computer device.

10. A computer based system capable of performing the method of claim 1 comprising at least one computer device comprising a processor-coupled to a memory, the memory having computer readable code, which when executed by the processor causes the computer based system to perform the method.

11. A method of performing an electronic transaction comprising:
(a) receiving a request over a network from a remote funding user to fund a transaction to purchase a product or service at a location using a third user purchaser computer device at said location;
(b) determining whether one or more rules associated with electronic transactions apply to the request from the funding user;
(c) processing the request if all rules determined to be applicable are satisfied; and
(d) denying the request if one or more rules determined to be applicable are not satisfied;
wherein said processing includes:
(i) transmitting confirmation of funds from said remote funding user for said transaction to said third user purchaser computer device; and
(ii) redeeming the funds at a point of sale for said purchase of said products or services.

12. The method of claim 11, further comprising receiving a funding request over a network from said third user purchaser computer device to approve and fund said transaction to purchase said product or service prior to said request.

13. The method of claim 12, further comprising:
(i) determining whether one or more rules associated with electronic transactions apply to the funding request;
(ii) processing the funding request if all rules determined to be applicable are satisfied;
(iii) denying the funding request if one or more rules determined to be applicable are not satisfied;
wherein said processing includes transmitting said funding request over said network to said funding user.

14. The method of claim 11, wherein said third user purchaser computer device is selected from the group consisting of: smartphone, tablet, computerized watch, and computerized eyewear.

15. A method of performing an electronic transaction comprising:
(a) receiving a request over a network from a purchasing user to approve and fund a transaction to purchase a product or service;
(b) determining whether one or more rules associated with electronic transactions apply to the request from the purchasing user;
(c) processing the request if all rules determined to be applicable are satisfied;
(d) denying the request if one or more rules determined to be applicable are not satisfied;
(e) transmitting said request to a first approving user selected from two or more approving parties;
(f) receiving acceptance of said request for said transaction from said first approving user;
(g) transmitting said request to a second approving user selected from two or more approving parties;
(h) receiving acceptance of said request for said transaction from said second approving user; and
(d) redeeming the funds at a point of sale for said purchase of said product or service.

16. The method of claim 15, wherein said two or more approving parties are selected based on one or more transaction parameters.

17. The method of claim 16, wherein said transaction parameters are one or more parameters selected from: (i) location, (ii) product type, (iii) day of week, and (iv) time of day.
